(19) United States
(12) Patent Application Publication
(10) Pub. No.: US 2018/0356805 A1
(43) Pub. Date: Dec. 13, 2018

(54) Data Source Agnostic Browser-Based Monitoring Display for Monitoring Manufacturing or Control Process

(71) Applicant: Honeywell Limited, Mississauga (CA)

(72) Inventors: Ajay Krishna, Bangalore (IN); Prashant Maranat, Bangalore (IN); Hrishikesh Sudhir Thakre, Bangalore (IN); Bharath Mandya Gopal, Bangalore (IN); Saravana Kumar Murugeshan, Bangalore (IN)

(21) Appl. No.: 15/615,840

(22) Filed: Jun. 7, 2017

(51) Int. Cl. G05B 19/418; H04L 29/08; G05B 19/042; G05B 15/02; H04L 12/26; G06F 17/30

(52) U.S. Cl. CPC G05B 19/41885; H04L 67/02; G06F 17/30424; G05B 15/02; H04L 43/08; G05B 19/042

(57) ABSTRACT

Monitoring displays on a browser run on devices connected to a server node to render the displays for manufacturing and process control for flat sheet products such as paper, rubber, plastic and packaging. Browser-based web displays access data from different data sources without any modification of the displays. Common communication layer includes: quality control system human-machine interface controller adapted to expose HTTP endpoints; and data aggregator that is connected to the controller and is data source agnostic. Device for monitoring and controlling process includes: web server with a Quality Control System (QCS) web display view and QCS display data web Application Programmer Interface, with the web server being connected to common communication layer. Web browser includes QCS web display, wherein the web browser is located on a zero-install client; and work station that includes an HMI display that comprises a QCS HMI control, wherein the web display can access data.

### FIELD OF THE INVENTION

The present invention relates to control systems and more specifically to a system and method that employ a zero-install web-based display to monitor or control a manufacturing and industrial process.

### BACKGROUND OF THE INVENTION

Processing facilities typically employ control systems that manage a variety of industrial equipment. Example processing facilities include sheet manufacturing of paper, plastics, metal and the like. Various controllers are used to control the operation of actuators and other industrial equipment in the processing facilities. The controllers monitor the operation of the industrial equipment, provide control signals to the equipment, and initiate corrective actions when the equipment malfunctions.

Manufacturing and process control systems currently use dedicated thick clients to monitor and control the system. A thin client is a computer program, which depends heavily on another computer (or a server) to fulfill its traditional computational roles. In contrast, with a traditional thick client, a computer program (or device) is designed to perform these roles by itself. A dedicated operator station is needed so a user must be physically located in front of a client station node and, thus, cannot be mobile. Currently, monitoring displays are bound to specific data sources. Adding new data sources is a non-trivial activity that may involve changes to the displays as well as a communication layer.

### SUMMARY OF THE INVENTION

The present invention is based in part on the development of monitoring displays that are available on a browser which can run on devices that are connected to a server node to render the displays. This architecture and design enable browser-based web displays to access data from different data sources without any modification of the displays.

In one aspect, the invention is directed to an apparatus for monitoring and controlling a process that includes:

a common communication layer that includes:
a quality control system human-machine interface (QCS HMI) controller adapted to expose Hypertext Transfer Protocol (HTTP) endpoints; and
a data aggregator that is connected to the data source controller with the data aggregator being data source agnostic.

In another aspect, the invention is directed to an apparatus for monitoring and controlling a process that includes:

a web server that includes a QCS web display view and a QCS display data web Application Programmer Interface (API), wherein the web server is connected to a common communication layer.

In yet another aspect, the invention is directed to an apparatus that includes:

a web browser that includes a QCS web display, wherein the web browser is located on a zero install client; and

a work station that includes an HMI display that comprises a QCS HMI control, wherein the web display accesses data from a data source without changing displays or common communication layer.

The browser-based web display reduces the initial cost of a control system as well as cost of ownership of operating the system. The invention allows for monitoring displays to be available, and viewed, on a browser that may be run on a personal computer (PC), laptop computer, tablet computer, smartphone, or mobile device which connects to a server node to render the displays. Multiple devices may be used with the browser to render a monitoring of the displays.

The invention is particularly applicable for use over the Internet or Intranet with web servers and web browsers. This technique allows for the use of a web browser with no specialized pre-installed code (known as a “zero install” web client) to operate on remote objects through a web server.

Features may include a zero install browser-based display that can monitor manufacturing and control systems by connecting to a server. Thick clients need not be set up because no installation is required on a client node. Once a server is set up, browser-based clients may connect to it by using any device that may run a browser with minimal capabilities. Displays that may fit into an infrastructure, such as for Internet of Things (IoT), enables data to be pulled from the cloud or from an edge device.

In a further aspect, the invention is directed to a method of monitoring and controlling a process, using an apparatus with a browser-based monitoring console that requires no installation on a client node, which includes the steps of:

connecting the apparatus to a server containing multiple data sources; and

viewing displays on the browser, wherein a browser displays data from the multiple data sources, wherein the displays are not modified when different data sources are accessed and wherein the displays are not modified when a new data source is added to the server.

While the invention will be illustrated as being implemented in papermaking, it is understood that the invention is applicable in general to any complex processing facility and to other continuous sheet making processes such as, for example, in the manufacturer of rubber sheets, plastic film, metal foil, and the like.

### BRIEF DESCRIPTION OF THE DRAWINGS

FIG. 1 is a schematic of a data source agnostic, zero-install web-based display;

FIG. 2 is a schematic of a monitoring and control apparatus incorporating a zero-install web-based display; and

FIG. 3 is a schematic illustration of a papermaking system monitored and controlled with a zero-install web-based display device.

### DETAILED DESCRIPTION OF PREFERRED EMBODIMENTS

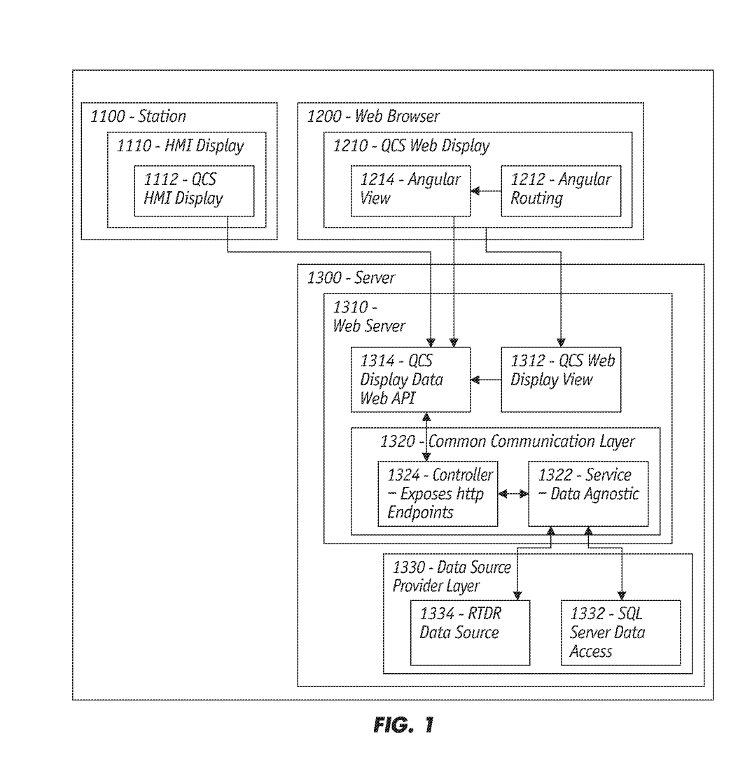

As shown in FIG. 1, the invention allows a browser-based web display 1210 to access data from different sources 1332, 1334 with no modification of the displays 1210. The invention allows for monitoring displays 1210 to be available, and viewed, on a browser 1200 that may be run on a PC, laptop computer, tablet computer, smartphone, or other handheld mobile device which connects to a server 1300 node to render the displays 1210. Multiple devices can be used with the browser to render a monitoring of the displays.

Features may include a zero install browser-based display 1210 that may monitor manufacturing processes and control systems by connecting to a server 1300. Thick clients need not be set up because no installation is required on a client node. Once a server 1300 is set up, browser-based clients may connect to it by using any device that may run a browser 1200. Displays 1210 may fit into an infrastructure, such as for Internet of Things (IoT). Data may be pulled from the cloud or from an edge device.

An example of a monitoring station is the EXPERION MX R700 model from Honeywell International, Inc. (Morristown, N.J.) which can be modified to incorporate the features of the present invention. The station 1100 may include a Human-Machine Interface (HMI) display 1110. The HMI display 1110 may include a Quality Control System (QCS) HMI controller 1112 which may be connected asynchronously with QCS display data web Application Program Interface (API) 1314 in a web server 1310 that is included in an EXPERION MX Server 1300.

A web browser 1200 may include a QCS web display 1210. The QCS web display 1210 includes angular routing 1212 that is connected asynchronously with angular view 1214. In other words, the QCS web can display infrastructure that includes client side routing and the QCS web display can be a single page application that renders multiple partial views. The angular view 1214 may, in turn, also be connected asynchronously with the QCS display data web API 1314 in web server 1310 that is included in the EXPERION MX Server 1300. The QCS web display 1210 is also connected asynchronously with the QCS web display view 1312.

A claimed system may have a common communication layer 1320 and a specific data source provider layer 1330, which can be a proprietary data source. A browser-based web display 1210 talks to the common communication layer 1320 using standard interfaces. The common communication layer 1320 talks to the specific data source providers 1332, 1334 using common interfaces.

A new data source provider 1332, 1334, such as using Open Platform for Communications (OPC), jointly developed by suppliers in automation industry for WINDOWS programs from MICROSOFT's original 1996 Object Linking and Embedding (OLE) for process control, may be plugged in the data source layer 1330 without affecting the communication 1320 or the web displays 1210. The OPC is a series of standards and specifications developed and published for connectivity of industrial telecommunication.

The web displays 1210 may access data from different data sources 1332, 1334 without any change to the display 1210 or the communications layer 1320. The claimed architecture and design may be reused in any product that requires browser-based monitoring displays 1210.

The browser-based web displays 1210 for process monitoring and control talks to Hypertext Transfer Protocol (HTTP) endpoints on a web server 1310 to read and write data to the process. It is understood that HTTP includes HTTP secure (HTTPS) which is a combination of HTTP and an encryption protocol. A controller 1324 exposes the HTTP endpoints to a service data aggregator 1322 that is data source-agnostic. The data source provider 1332, 1334 may include asynchronous access to real-time data reporting data 1334, as well as, to Structured Query Language (SQL) server data 1332.

A data source provider layer 1330 may include a data source provider 1332, 1334. The data source provider 1332, 1334 may contain actual data source access logic, including real-time data reporting 1334 and Control Data Access (CDA) data. A repository converts data to be consumed by the data aggregator 1322.

The claimed architecture and design allow the displays 1210 to be independent of the data source 1332, 1334. A new data source provider 1332, 1334 component for a specific data source may be plugged into the system to enable access of data without any change to the displays 1210 or any other part of the communication layer 1320 of the system.

The area of telecommunications and networking has evolved continuously for many years. The physical media, transmission protocols, network designs, and communication systems for both wire-linked and wireless networks have advanced to increase speed and bandwidth of the implemented connectivity thus enabling many applications and services.

To minimize proprietary solutions and encourage an open market, the International Organization of Standardization (ISO) has developed a generic Open Systems Interconnection (OSI) reference model that distinguishes between specification (layers) and implementation (protocols). An open system promotes competition that tends to lower cost for products. The OSI reference model standardizes the protocols used in the protocol stacks, thus, resulting in specification of interfaces between layers.

Most networks may be organized into 1-7 layers to reduce complexity in network design. The layers represent different levels of abstraction and functionality in the service provided. In a layered network of communication nodes, each protocol layer of a node communicates with the equivalent, or corresponding, protocol layer of another node. Sets of rules specify the structure and semantics of the information exchanged. The concepts of service and protocol that correspond to each layer have been published by ISO.

The 7 layers, from bottom to top, are as follows.

Layer 1 is defined as Physical layer which includes typical functions such as signal processing, timing, and encoding. Its protocols use methods for bit transmission over physical media. The physical layer defines the electrical interface, such as type of signal (electrical or optical or wireless) and connectors to be used by the network interface card (NIC). The physical layer also performs modulation and demodulation.

Layer 2 is defined as Data Link Control (DLC) layer which includes such functions as organization of bits into data units (frames) organization, error detection, and flow control. Its protocols set up point-to-point communication over a physical or logical link.

Layer 3 is defined as Network layer which identifies the route or pathway the data units will take from the source to the destination. Its protocols deliver data units over a network composed of the links established through the DLC protocols of layer 2.

Layer 4 is defined as Transport layer which includes end-to-end error detection, retransmissions, and flow control. Its protocols ensure Quality of Service (QoS) by establishing reliable, in other words, complete and correct, data transfer between end systems over the network defined by layer 3 protocol.

Layer 5 is defined as Session layer that enables and manages sessions for complete data exchange between end nodes, in other words, the source and the destination. The sessions may include multiple transport layer connections.

Layer 6 is defined as Presentation layer that ensures data are exchanged in formats that may be consumed by the Application layer. The Presentation layer is responsible for representation of information, such as ASCII, encryption, and decryption.

Layer 7 is the Application layer. Its protocols implement, or facilitate, end-to-end distributed applications over the network for the users to access. Examples of Layer 7: Applications layer include email, File Transfer Protocol (FTP), and Telnet.

Layer 1 is the lowest layer in the OSI reference model while layer 6 is the highest layer. Due to influence of standardization by IEEE 802 committee for Local Area Network (LAN), layer 2 may be further divided into 2 sublayers: a Media Access Control (MAC) sublayer above layer 1 and a Logical Link Control (LLC) sublayer above the MAC sublayer. For devices within a Wireless Local-Area Network (WLAN) or IEEE 802.11, the physical layer uses Infrared (IR) or Radio Frequency (RF) signals, including Bluetooth (IEEE 802.15.1), as transmission media for information.

The Internet era has resulted in the dominance of the Transmission Control Protocol (TCP)/Internet Protocol (IP) reference model. The TCP/IP reference model has followed the paradigm of the OSI reference model, including analogies for the 4 lower layers and the highest layer of the OSI reference model while dropping the other layers.

The TCP/IP reference model may be considered as a special case of the OSI reference model. IP is an example of Layer 3: Network layer while TCP is an example of Layer 4: Transport layer.

HTTP is messaging protocol that sits on top of TCP/IP. HTTP handles the actions required for web browser to interact with web resources. The HTTP specification specifies 8 core methods, including GET and POST. HTTP is a stateless protocol in that no connection persists between multiple requests. Each incoming HTTP request is treated separately and the web server does not care about any previous request made by the same client.

File Transfer Protocol (FTP) also sits on top of TCP/IP.

Product differentiation may be accomplished by defining new network architectures and new network protocols. Protocol implementations may be composed of 3 elements, that is, mechanisms; syntax; and system design and implementation. The mechanisms and the syntax are typically defined by standards. However, system design and implementation are not influenced by efforts to standardize protocols.

Wireless sensor and control networks have become an important part of the automation process, such as within commercial buildings, residential buildings, hospitals, oil refineries, and chemical plants. For example, applications for industrial and process automation may include sensing and control of pressure, volume, temperature, fluid flowrate, fluid level, and electronic parameters, such as electrical voltage, electrical current, and electrical power distribution. Other applications include lighting control, meter reading, and security monitoring.

To accommodate this technology, many standards have been developed, including SP100.11 (Wireless Systems for Automation) by the Industrial Standard for Automation (ISA), Wireless Highway Addressable Remote Transducer (HART) by the HART organization, IPv6 over low-power personal-area network (6lowpan) by the Internet Engineering Task Force (IETF), and ZigBee by the ZigBee Alliance. ZigBee is a Personal-Area Network (PAN) standard specifically for a low-rate or low-power wireless sensor and control network.

In particular, the many standards that currently exist for wireless technologies may be used for data transfer: Wireless Local Area Network (WLAN) (IEEE 802.11), Bluetooth (IEEE 802.15.1), Wireless Metropolitan Area Network or Broadband Wireless Access (BWA) (IEEE 802.16), Ultra Wideband (IEEE 802.15.3) and 4 G LTE (IMT Advanced).

A network may include devices as nodes. A node may include a microcontroller, a transceiver, and an antenna. The node uses stack profiles that are developed by software. A node may support multiple subunits. Each subunit has an application object that describes the subunit function. The node may operate as a full-function device (FFD) or a reduced-function device (RFD). The FFD may perform all the tasks that are defined by the standard and may operate, such as in the full set of the IEEE 802.15.4 MAC layer. In contrast, the RFD may only perform a limited number of tasks.

A reference architecture may include a resource tier, a service tier, connectivity, client tier, and tools for design, development, and governance.

The resource tier is the bottom tier. It includes files, databases, directories, Enterprise Information System (EIS), such as Enterprise Resource Planning (ERP) system and Customer Relationship Management (CRM) system, Enterprise Content Management (ECM) repository, message queues, legacy systems, and other common applications.

The client tier displays graphical views of service calls to users so they can consume services. Implementations of client-side software include web browsers, Adobe Flash Player, Microsoft Silverlight, and Adobe Acrobat. There may be communication services, data/state management, security container/model, virtual machine, rendering and media, with controller.

A set of tools enables designers and developers to build web applications. The tools allow them to view into both the service tier and the client tier. Many Integrated Development Environments (IDE) are available. Alternatively, a custom set of tools may be used.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

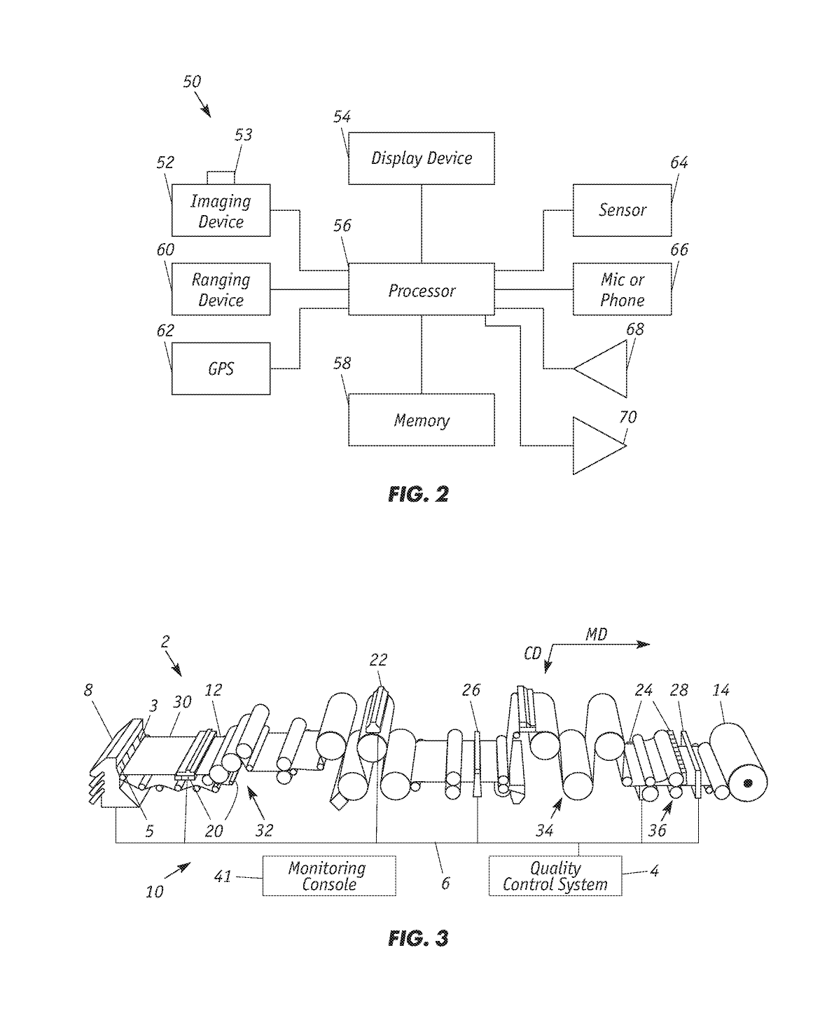

FIG. 2 is an embodiment of the zero-install web-based display monitoring console apparatus 50 that includes an imaging device 52 that is equipped with lens 53, a display device 54, a processor 56, and a memory medium 58. In the case of monitoring a papermaking process, paper quality measurement information is stored in the memory medium 58. For a particular grade of paper being produced with a specific papermaking machine, the paper quality measurement information can include, for example, color maps and profiles of paper produced under different conditions. In addition, the information pertains to different specific locations along the machine direction of a papermaking machine.

Suitable imaging devices 52 include a digital camera and a video camera that captures video in a frame-by-frame manner. Apparatus 50 can also include a ranging device 60 which is configured to determine a distance from ranging device 60 to a sheet and other surfaces and a global positioning system receiver (GPS) 62 which is configured to determine the position of system 50. The apparatus 50 can include a sensor 64 for recognizing actions by an operator and a microphone 66 for capturing voice commands or inputs from an operator. The processor 56 can be configured for speech recognition and gesture detection so that hand or finger gestures by the operator are identified as user commands to operate apparatus 50.

Finally, apparatus 50 can include a receiver 68 for receiving data from a quality control system of a papermaking machine and a transmitter 70 for transmitting data to the quality control system. For instance, during paper production, various scanners are employed to measure paper quality. The measurements can be transmitted to apparatus 50 and stored in memory device 58. The components of the data source agnostic browser-based monitoring display (FIG. 1) are incorporated into apparatus 50, which can be a portable computer device that are equipped with cameras, such as tablets and smartphones, that have been modified and programmed.

In operation, a user of apparatus 50 that wishes to access the Internet or World Wide Web (WWW) typically does so using a software application known as a web browser that has been installed. Typical examples of web browsers are MICROSOFT INTERNET EXPLORER, GOOGLE CHROME, MOZILLA FIREFOX and APPLE SAFARI. A user that accesses the WWW with a web browser is known as a web client. Web browsers communicate with computer systems called web servers. Typically, a web client accesses a resource on the WWW by transmitting a special address known as a Uniform Resource Locator (URL) to the web server. A URL identifies a particular web server and a particular resource on the web server that the web client wishes to access. The web server then delivers the resource to the web browser.

The web server thus delivers resources when requested by the client. In this case, the use is able to monitoring and controlling complex industrial process by connecting to a server.

A web browser receives data from the web server and displays that data on the apparatus 50. The communication between web browsers and web servers is done according to any of several Internet protocols such as, hypertext transfer protocol (HTTP), which is the most common.

Standard HTML pages can be used to deliver a wide range of information to the web browser, but are limited in that they are essentially static. The static nature of HTML pages limits the amount of interactivity they can provide between the web client and the web server. Without full interactivity between web clients and web servers, the full potential of the Internet could not be reached.

The zero-install web-based display monitoring console of the present invention is particularly suited for monitoring and controlling complex processes that require information from a plurality of data sources. The monitoring display is not specifically bound to data sources and the architecture and design enable browser based web displays to access data from different sources with no modification to be done to the monitoring display. For example, a monitoring display of the present invention can be employed to monitor and control process a sheetmaking system 10 that includes papermaking machine 2, quality control system 4 and network 6 as shown in FIG. 3. The papermaking machine 2 produces a continuous sheet of paper material 12 that is collected in take-up reel 14. The paper material 12 is produced from a pulp suspension feedstock, comprising of an aqueous mixture of wood fibers and other materials, which undergoes various unit operations that are monitored and controlled by a quality control system 4. The network 6 facilitates communication between the components of system 10.

The papermaking machine 2 includes a headbox 8, which distributes an aqueous pulp suspension uniformly across the machine onto a continuous screen or wire 30 that is moving in the machine direction (MD). Headbox 8 includes slice openings through which the pulp suspension is distributed onto screen or wire 30 which comprise a suitable structure such as a mesh for receiving a pulp suspension and allowing water or other materials to drain or leave the pulp suspension. The formation of the paper sheet 12 is influenced by a plurality of linear actuators 3 extending in the cross direction across the sheet 12 of paper being formed. Actuators 3 control the sheet's weight in the cross direction (CD). Sensors located downstream from the actuators measure the properties of the sheet. The feedstock is fed from the head box through a gap or elongated orifice 5 onto a wire section 30. Weight profile control in such an arrangement is achieved by locally adjusting the position of the slice lip across the machine with motorized linear actuators 3 to vary the dimensions of the gap or orifice immediately adjacent the actuator.

Sheet 12 then enters a press section 32, which includes multiple press rolls where sheet 12 travels through the openings (referred to as “nips”) between pairs of counter-rotating rolls in press section 32. In this way, the rolls in press section 32 compress the pulp material forming sheet 12. As sheet 12 travels over a series of heated rolls in dryer section 34, more water in sheet 12 is evaporated. A calendar 36 processes and finishes sheet 12, for example, by smoothing and imparting a final finish, thickness, gloss, or other characteristic to sheet 12. An array of induction heating actuators 24 applies heat along the CD to one or more of the rollers to control the roll diameters and thereby the size of the nips. Once processing by calendar 36 is complete, sheet 12 is collected onto reel 14.

Sheetmaking system 10 further includes an array of steam actuators 20 that controls the amount of hot steam that is projected along the CD. The hot steam increases the paper surface temperature and allows for easier cross direction removal of water from the paper sheet. Also, to reduce or prevent over drying of the paper sheet, paper material 14 is sprayed with water in the CD. Similarly, an array of rewet shower actuators 22 controls the amount of water that is applied along the CD.

In order to control the papermaking process, selected properties of sheet 12 are continuously measured and the papermaking machine 2 adjusted to ensure sheet quality. Typical physical characteristics of paper that are can be measured include, for example, thickness, basis weight, moisture content, chemical composition, surface roughness, gloss, caliper, and crepe pattern surface features. CD control may be achieved by measuring sheet properties using one or more scanners 26, 28 that are capable of scanning sheet 12 and measuring one or more characteristics of sheet 12. For example, scanner 28 could carry sensors for measuring the dry weight, moisture content, ash content, or any other or additional characteristics of sheet 12. Scanner 28 includes suitable structures for measuring or detecting one or more characteristics of sheet 12, such as a set or array of sensors.

Measurements from scanners 26 and 28 are provided to control system 4 that adjusts various operations of papermaking machine 2 that affect machine direction characteristics of sheet 12. A machine direction characteristic of sheet 12 generally refers to an average characteristic of sheet 12 that varies and is controlled in the machine direction. In this example, control system 4 is capable of controlling the dry weight of the paper sheet by adjusting the supply of pulp to the headbox 8. For example, control system 4 could provide information to a stock flow controller that regulates the flow of stock through valves and to headbox 8. Control system 4 includes any hardware, software, firmware, or combination thereof for controlling the operation of the sheetmaking machine 2 or other machine. Quality control system 4 can, for example, include a processor and memory storing instructions and data used, generated, and collected by the processor.

With the present invention, a monitoring console 41 that is a data source agnostic browser based monitoring display is employed to connect to a server node to render the displays. In monitoring console 41 can be a PC, laptop or mobile device. In this fashion, an operator can readily access the data from a plurality of data sources and monitor and control the sheetmaking process by just connecting to a server. For example, during a grade change when the operating parameters of the papermaking machine are reconfigured to make a different grade of paper, an operator can access the new operating parameters through the Internet with monitoring console 41. The operating parameter information is used to adjust actuators using measurement signals provided by scanning sensors. In the case of CD control, common control scheme measures values at selected CD locations on a sheet and then compares those measured values to target or setpoint values. The difference for each pair of measured and setpoint values—the error—can be used for algorithmically generating appropriate outputs to CD control actuators to minimize the error.

With the present invention, there is no need to set up thick clients. This allows for remote data access practically from anywhere in the world with an Internet connection. It is expected that displays will easily fit into future Internet of Things based cloud infrastructure wherein the displays can be enabled to pull data from the cloud or even from an edge device.

The monitoring console 41 communicates with quality control system 4 which provides output signals that are indicative of the magnitude of measured sheet properties for regulating control devices at various stages of the papermaking process so that the final sheet product meet specifications.

The foregoing has described the principles, preferred embodiments and modes of operation of the present invention. However, the invention should not be construed as being limited to the particular embodiments discussed. Thus, the above-described embodiments should be considered as illustrative rather than restrictive, and it should be appreciated that variations may be made in those embodiments by workers skilled in the art without departing from the scope of the present invention as defined by the following claims.

What is claimed is:

1. An apparatus for monitoring and controlling a manufacturing or control process that comprises:
a common communication layer that includes:
a quality control system human-machine interface (QCS HMI) controller adapted to expose Hypertext Transfer Protocol (HTTP) endpoints; and
a data aggregator that is connected to the controller wherein the data aggregator being data source agnostic.

2. The apparatus of claim 1 further comprising a data source provider layer that includes:
a real-time data reporting data source provider that includes:
actual data source access logic; and
a repository adapted to convert data to be consumed by the data aggregator.

3. The apparatus of claim 2 wherein the data source provider layer includes a Structured Query Language (SQL) compliant data source provider.

4. The apparatus of claim 3 further comprising a QCS web display that is connected to a web browser that is located on a zero install client.

5. The apparatus of claim 4 wherein the QCS web display is an infrastructure that includes client side routing.

6. The apparatus of claim 5 wherein the QCS web display is a single page application that renders multiple partial views.

7. The apparatus of claim 5 wherein the connections are asynchronous.

8. An apparatus for monitoring and controlling a process that comprises:
a web server that includes a quality control system (QCS) web display view and a QCS display data web Application Programmer Interface (API), wherein the web server is connected to a common communication layer.

9. The apparatus of claim 8 wherein the common communication layer includes a data aggregator that is data source agnostic wherein the data aggregator uses a common set of interfaces to interact with different data source providers and a controller that exposes Hypertext Transfer Protocol (HTTP) endpoints.

10. The apparatus of claim 9 wherein the data aggregator is connected to multiple real time data reporting data access data source providers.

11. The apparatus of claim 9 wherein the data aggregator is connected to a Structured Query Language (SQL) server data access.

12. The apparatus of claim 11 wherein upper layers and web display all remain unchanged when a new data source provider is added that reads data from a currently not supported SQL server data access.

13. An apparatus comprising:
a web browser that includes a quality control system (QCS) web display, wherein
the web browser is located on a zero install client; and
a work station that includes a human-machine interface (HMI) display that comprises a QCS HMI control, wherein the web display can access data from a data source without changing displays or common communication layer.

14. The apparatus of claim 13 further comprising a server.

15. The apparatus of claim 14 further comprising a web server.

16. A method of monitoring and controlling a process, using an apparatus with a browser-based monitoring console that requires no installation on a client node, which comprises:
connecting the apparatus to a server containing multiple data sources; and
viewing displays on the browser, wherein a browser displays data from the multiple data sources, wherein the displays are not modified when different data sources are accessed and wherein the displays are not modified when a new data source is added to the server.

17. The method of claim 16 wherein the apparatus includes a common communication layer that includes:
a quality control system human-machine interface (QCS HMI) controller adapted to expose Hypertext Transfer Protocol (HTTP) endpoints; and
a data aggregator that is connected to the controller wherein the data aggregator being data source agnostic.

18. The method of claim 16 wherein the apparatus comprises: a web server that includes a quality control system (QCS) web display view and a QCS display data web Application Programmer Interface (API), wherein the web server is connected to a common communication layer.

19. The method of claim 16 further comprising implementing corrective action on the process by input instructions through the apparatus.

20. The method of claim 16 wherein the apparatus is a portable computer.

21. The method of claim 16 wherein the process manufactures a sheet product made of paper, plastic, rubber or metal.
